(19) United States
(12) Patent Application Publication
(10) Pub. No.: US 2014/0087049 A1
(43) Pub. Date: Mar. 27, 2014

(54) Shelf Stable Liquid Sweetener and Flavor Additive

(71) Applicant: INTERNATIONAL FOOD NETWORK INC, Ithaca, NY (US)

(72) Inventors: Chandrakant Ramesh ANKOLEKAR, Ithaca, NY (US); Peter M. SALMON, Ithaca, NY (US)

(73) Assignee: International Food Network Inc, Ithaca, NY (US)

(21) Appl. No.: 13/857,055

(22) Filed: Apr. 4, 2013

Related U.S. Application Data
(60) Provisional application No. 61/706,020, filed on Sep. 26, 2012.

(51) Int. Cl. A23L 1/221

(52) U.S. Cl. CPC A23L 1/221
USPC 426/548

(57) ABSTRACT

A shelf stable liquid sweetener and flavor additive is a food additive that increases the palatability and sweetness of a plurality of food products. The shelf stable liquid sweetener and flavor additive is a formulation of various naturally occurring compounds and extracts that are obtained through non-chemically assisted means. The present invention enhances the sweetness and palatability of food product but contains a negligible caloric content. Additionally the present invention is able to be safely stored in a sealed container at ambient temperature for several months. The present invention comprises a plurality of natural compounds that function as water activity reducing compounds, stabilizing compounds, preservatives, and flavoring compounds as well as a natural high intensity sweetener. Through the formulation of the various natural components the present invention is able to maintain a water activity value that is below 0.8 and a pH value below 4.2.

The current application claims a priority to the U.S. Provisional Patent application Ser. No. 61/706,020 filed on Sep. 26, 2012.

### FIELD OF THE INVENTION

The present invention relates generally to a food additive, more specifically to a natural shelf stable liquid sweetener and flavor additive that is utilized to enhance the flavor and sweetness of a plurality of food products.

### BACKGROUND OF THE INVENTION

It is well known that there are various sweeteners available to enhance the sweetness of a plurality of food products. Generally existing sweeteners can be separated into two groups that consist of natural sweeteners and synthetic sweeteners. Natural sweeteners are naturally occurring compounds extracted from various sources that when combined with a food product, greatly increases the sweet taste of said food product. Traditionally natural sweeteners are regarded as naturally occurring compounds and mixtures that contain large quantities of sugars as well as various other organic compounds with sweetening properties. These sugars generally consist of glucose, fructose, galactose, sucrose, maltose, lactose, and combinations thereof. Generally natural sweeteners are provided as crystalline granules that can easily dissolve or as dense highly concentrated solutions such as various syrups and honey. In addition to enhancing the sweetness of various food products, natural sweeteners provide a distinct flavoring that is unique to the particular natural sweetener. Although these natural sweeteners are historically regarded as effective sweeteners, there are several disadvantages associated with their use. A significant disadvantage associated with natural sweeteners is related to their nutritional value. Most food products that utilize natural sweeteners have a high caloric content due to the amount of sugars needed to effectively sweeten said food product. While the high caloric content is not a problem in and of itself, frequent consumption of natural sweeteners can lead to weight gain or more serious medical conditions. As a response to health concerns alternative sweetener substitutes have been developed to provide sweetness without the high caloric content.

One class of alternative sweeteners that have been developed are referred to as High intensity sweeteners (HIS). High intensity sweeteners are naturally occurring or artificially synthesized compounds that provide an intense sweetness to a food product. These high intensity sweeteners are many times the sweetness of regular table sugar and as a result a minute quantity of sweetener, with negligible caloric value, can be utilized to achieve the same level of sweetness as regular table sugar. These high intensity sweeteners can be dissolved in a solvent such as water with added bulking agents such as sugar, maltodextrins, sugar alcohols, and high molecular weight polysaccharides to provide a convenient, rapidly dissolving sugar-syrup like product. However, these convenient syrup products are not always natural and typically contain synthetic and artificial compounds, such as synthetic preservatives, synthetic polyols, and artificially derived high intensity sweeteners. While synthetic and artificial compounds are technically regarded as safe, several studies have suggested a plurality of serious negative side effects associated with long term consumption of artificial sweeteners and preservatives. As a result many consumers tend to avoid foods that contain synthetic additives and preservatives.

Various prior arts have attempted to find an effective alternative sweetener composition with various degrees of success. For example, In U.S. Pat. Nos. 4,927,646, 4,031,259 and 2006/0246207 alternative methods of increasing the functional properties of high intensity sweetener are mentioned by co-drying the high intensity sweetener with a bulking agent. This product however, does not provide convenience of using sweeteners in a shelf-stable liquid form. Another example is U.S. Pub. No. US2007/0020368, which describes an all natural low glycemic, high fiber composition for providing sweet flavor. This prior art is a powdered composition, not a liquid composition and if it were converted to a liquid it would not be microbiologically stable at room temperature over an extended shelf-life. Still another set of examples are U.S. Pub. No. 2008/0268109 and U.S. Pub. No. 2009/0226575 which describe a low glycemic sweetener composition that can reduce gastrointestinal distress when ingested. This prior art does not contain any details regarding the shelf stability of the composition nor does it utilize naturally derived components. Yet another prior art example is U.S. Pub No. 2008/0299258 which describes a prebiotic syrup derived from agave and that contains standardized levels of inulin fiber, exceeding 30% by weight of the syrup. In one embodiment it describes use of high intensity sweeteners and flavors and a liquid composition is described. Although this prior art describes a possible liquid composition that is shelf-stable, the ingredient composition would have to be very high to ensure microbiological stability at room temperature. The syrup that is described would not be of a viscosity that would flow at room temperature or could be dispensed by the consumer through a controlled delivery silicon valve. Furthermore, if the pH of the syrup were depressed to enhance preservation then the fiber component would hydrolyze at room temperature such that within less than 90 days at room temperature the solids would be mostly fructose and a zero calorie label claim would not be possible.

It is therefore the object of the present invention to provide a natural shelf stable liquid sweetener that additionally functions as a flavor additive. The present invention accomplishes this through the use of naturally occurring compounds and extracts combined in a shelf stable liquid mixture that can effectively substitute existing sweeteners as a low calorie, or calorically negligible, convenient alternative to nutritive sweeteners. The present invention utilizes a plurality of naturally occurring compounds and extracts obtained through non-chemically assisted means to form a liquid mixture for use with a variety of food products. The liquid mixture contains a plurality of compounds that cooperatively function to reduce the water activity and achieve the target acidity of the liquid mixture, in order to achieve long-term shelf stability. In addition to functioning as a liquid sweetener the present invention is provided as a flavor enhancer that can be used to change the flavor of a plurality of food products. The present invention is completely natural and employs no synthetic preservatives. The composition described here is shelf stable due to a unique combination of factors including low water activity (<0.8), low pH and use of natural antimicrobial agents. This unique combination of factors makes it possible to now deliver the convenience of a liquid shelf-stable concentrate in a natural format. The present invention may be seen as an improvement over U.S. Pub No. 2008/0299258 and U.S. Patent No. US2007/0020368 by virtue of overcoming the challenges of providing shelf stable liquid sweetening and flavoring base in an all natural form.

### BRIEF DESCRIPTIONS OF THE DRAWINGS

FIG. 1 is a block diagram displaying the component ingredients utilized in the preferred embodiment of the shelf stable liquid sweetener and flavor additive.

TABLE 1 shows the component ingredients of the preferred embodiment of the shelf stable liquid sweetener and flavor additive with percent weight ranges and a brief description of function.

FIG. 2 is a block diagram displaying the component ingredients utilized in the liquid sweetener formulation of the shelf stable liquid sweetener and flavor additive.

TABLE 2 shows the component ingredients of the liquid sweetener formulation of the shelf stable liquid sweetener and flavor additive with percent weight ranges and a brief description of function.

FIG. 3 is a block diagram displaying the component ingredients utilized in the flavor additive formulation of the shelf stable liquid sweetener and flavor additive.

TABLE 3 shows the component ingredients in the flavor additive formulation of the shelf stable liquid sweetener and flavor additive.

FIG. 4 is a block diagram displaying the group of ingredients that corresponds to the stabilizing and water activity reducing compound.

FIG. 5 is a block diagram displaying the group of ingredients that corresponds to the high intensity sweetener.

FIG. 6 is a block diagram displaying the group of ingredients that corresponds to the buffering agent.

FIG. 7 is a block diagram displaying the group of ingredients that corresponds to the tart tasting water activity reducing compound.

TABLE 4 shows component ingredients for the shelf stable liquid sweetener and flavor additive with corresponding ingredient groups, preferred ingredient, and a description of similarities between component ingredients of a particular group.

FIG. 8 is a block diagram displaying the component ingredients that further comprises the at least one flavoring and water activity reducing compound and the flavored water activity reducing compound for the tea flavored formulation and the lemonade flavored formulation of the present invention.

TABLE 5 shows the component ingredients, the particular elected ingredient, the percent weight of said ingredient in the lemonade flavored formulation of the shelf stable liquid sweetener and flavor additive.
TABLE 6 shows the component ingredients, the particular elected ingredient, the percent weight of said ingredient in the tea flavored formulation of the shelf stable liquid sweetener and flavor additive.
TABLE 7 shows the component ingredients, the particular elected ingredient, the percent weight of said ingredient in the liquid sweetener formulation of the shelf stable liquid sweetener and flavor additive.

### DETAIL DESCRIPTIONS OF THE INVENTION

All illustrations of the drawings are for the purpose of describing selected versions of the present invention and are not intended to limit the scope of the present invention.

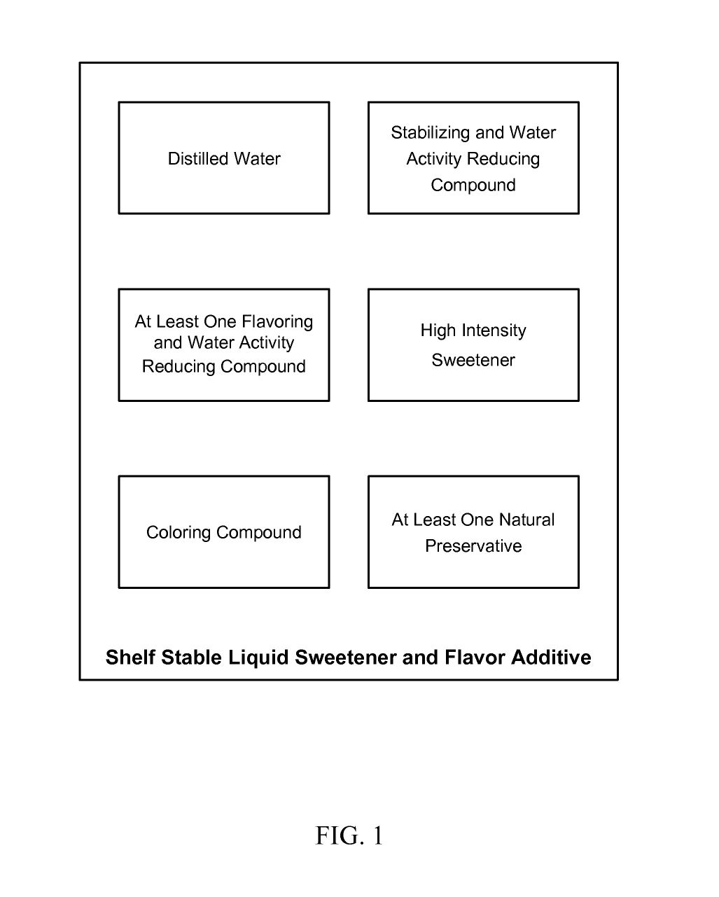

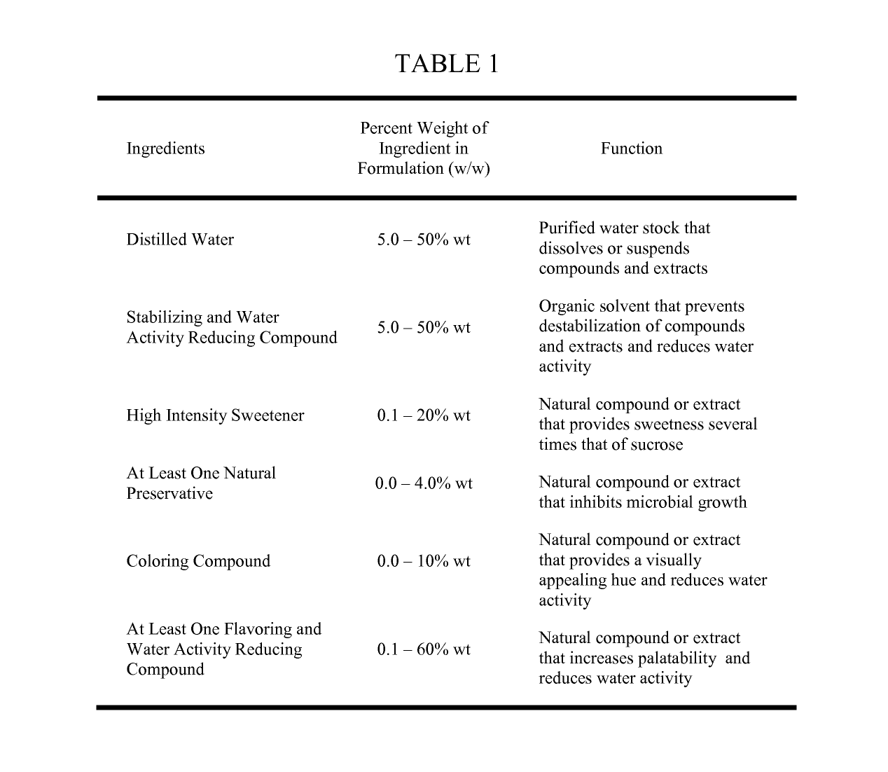

Referencing FIG. 1, the present invention is a shelf stable liquid sweetener and flavor additive that utilizes a mixture of naturally occurring compounds, extracts, and derivatives to provide enhanced sweetness and flavoring, with negligible caloric content, to a plurality of consumable products. It should be noted that shelf stable is defined as a food product that can be stored without refrigeration in a sealed container at room or ambient temperature for a period of not less than nine months. The shelf stable liquid sweetener and flavor additive is a liquid mixture comprising distilled water, a stabilizing and water activity reducing compound, a high intensity sweetener, at least one natural preservative, a coloring compound, and at least one flavoring and water activity reducing compound. The distilled water is provided as a purified water stock for dissolving, suspending, and dispersing compounds, extracts, and combinations thereof utilized in the liquid mixture. The stabilizing and water activity reducing compound is provided as a natural organic solvent that reduces unwanted interactions between ingredients while additionally lowering the water activity (a_{w}) of the liquid mixture. The high intensity sweetener (HIS) is a natural extract or combination of natural extracts that functions as the natural sweetener. The at least one natural preservative is a naturally occurring compound, extract, or combination thereof that functions as a microbiological stabilizer for the liquid mixture. The coloring compound is a natural extract or compound that provides a visually appealing hue to the liquid mixture. The at least one flavoring and water activity reducing compound is a naturally occurring compound, extract, or combination thereof, that is provided as palatable additive that additionally functions to lower the a_{w} of the liquid mixture.

It should be noted that Water activity (a_{w}) is defined as the vapor pressure of a liquid divided by the vapor pressure of pure water at the same temperature. Water activity is a measure of the energy status in a liquid mixture and is used as a measure of the intensity with which water associates with various non-aqueous constituents and solids. It is well documented that water activity is related to microbial growth. Generally, liquid mixtures with a lower water activity are found be unsuitable to support microbial growth. It is well known that liquid mixtures with water activity values of less than 0.7 are not conducive for microbial growth.

Referencing FIG. 1 and TABLE 1, the shelf stable liquid sweetener and flavor additive in the present invention comprises distilled water, a stabilizing and water activity reducing compound, a high intensity sweetener, at least one natural preservative, a coloring compound, and at least one flavoring and water activity reducing compound, where the combination of the aforementioned ingredients creates a shelf stable liquid mixture. The aforementioned ingredients of the shelf stable liquid sweetener are provided with specific quantity ranges that achieve a water activity (a_{w}) value that is below 0.85 and a pH value that is below 4.6. The distilled water is found present ranging between 5.0-50% wt. The stabilizing and water activity reducing compound is found present ranging between 5.0-50% wt. The high intensity sweetener (HIS) is found present ranging between 2.0-20% wt. The at least one natural preservative is found present ranging between 0.0-4.0% wt. The at least one flavoring and water activity reducing compound is found present ranging between 0.1-60% wt. The coloring compound is found present ranging between 0-10% wt. In the aforementioned quantity ranges for the ingredients of the present invention, the shelf stable liquid sweetener and flavor additive was determined to have a water activity (a_{w}) value being below 0.8 and a pH value below 4.2. The values calculated for the water activity (a_{w}) and the pH provides the present invention with resistance to microbial contamination at ambient temperatures for a period of at least 9-18 months.

The distilled water in the present invention is provided as the purified water stock for dissolving or suspending, compounds, extracts, and combinations thereof, utilized in the liquid mixture. The distilled water is found in present invention ranging between 5.0-50 percent weight % wt of the liquid mixture. Distilled water is selected as the preferred purified water stock for its reduced mineral ion concentration and microbial activity concentration. The reduced mineral ion concentration lowers unwanted and unintended interactions between ingredients and the reduced microbial activity provides a lower contamination risks.

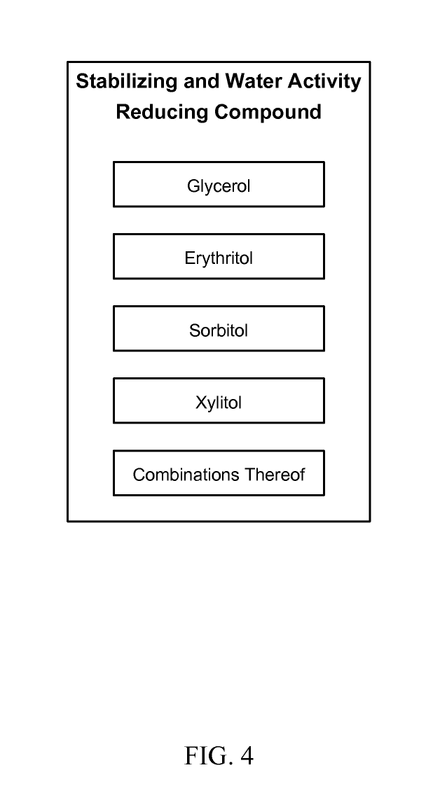

Referencing FIG. 4 and TABLE 4, the stabilizing and water activity reducing compound in the present invention functions as an organic solvent that prevents denaturation of compounds and extracts utilized in the liquid mixture. The stabilizing and water activity reducing compound is used in combination with distilled water forming a solvent mixture with reduced water activity. The stabilizing and water activity reducing compound is found in the present invention ranging between 5.0-50% wt. The stabilizing and water activity reducing compound is selected from a group of organic compounds that consist of polyols, specifically sugar alcohols, with similar stabilizing and water activity reducing properties. The group of polyols consists specifically of Glycerol, Erythirtol, Sorbitol, and Xylitol, as well as any combination thereof. In the preferred embodiment of the present invention, the stabilizing and water activity reducing compound is Glycerol. In the preferred embodiment of the present invention, Glycerol is selected as the stabilizing and water activity reducing compound. Glycerol, additionally referred to as glycerin, is a simple polyol with extensive documentation describing it as an effective organic solvent. Glycerol is a stable organic solvent that prevents denaturation of botanical compounds and extracts that through its intrinsic properties reduce bi-molecular nucleophilic substitutions (S_{N}2 reactions) and reduction oxidization reactions (redox reactions) of the organic compounds and extracts within a mixture. Furthermore, glycerol functions as a water activity reducing compound through its hygroscopic properties which reduces the vapor pressure of the liquid mixture, resulting in a lowered water activity (a_{w}) value.

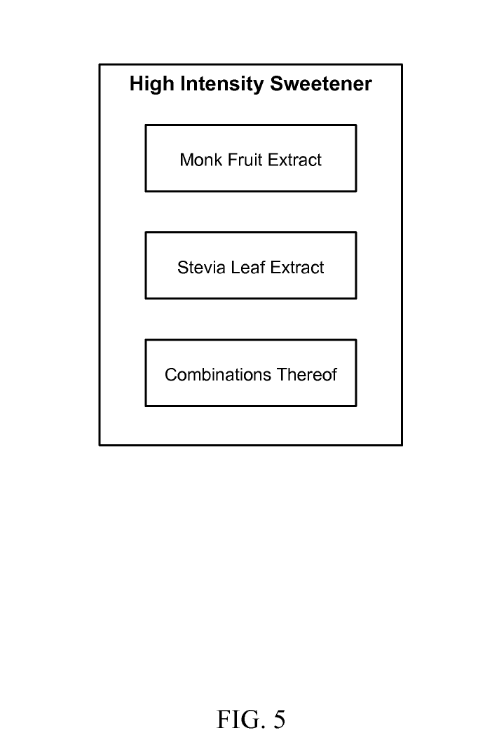

Referencing FIG. 5 and TABLE 4, the high intensity sweetener (HIS) utilized in the present invention is a natural organic compound that duplicates the sweetening effects of sucrose, commonly referred to as table sugar. The HIS functions as a sugar substitute but is differentiated by having a sweetening effect several times as sweet as sucrose. The increased sweetening effect of the HIS allows for minute quantities of the HIS to be used in the liquid mixture compared to sucrose, wherein the minute quantity of the HIS utilized in the present invention are able to provide the same amount of sweetness as significantly greater quantities sucrose while being of negligible caloric value. The high intensity sweetener is found in the present invention ranging between 0.1-20% wt. The high intensity sweetener is selected from a group of natural high intensity sweeteners derived from botanical extracts. The group of natural high intensity sweeteners consists of botanical extracts from Stevia rebaudiana, commonly referred to as Stevia leaf extract, and Siraitia grosvenorii, commonly referred to as monk fruit extract, as well as combinations thereof. In the preferred embodiment of the present invention, the high intensity sweetener is monk fruit extract. The monk fruit extract is selected as the high intensity sweetener in the preferred embodiment of the present invention for a having a sweetness 150-400 times that of sucrose. The monk fruit extract is well documented as being stable at high temperatures, being stable in solution, having low pH, and having a sweetness profile generally referred to as clean.

The at least one natural preservative utilized in the present invention is provided as a naturally occurring food additive that prevents the decomposition of the liquid mixture. The at least one natural preservative functions as a microbiological stabilizer, that limits bacterial and fungal growth in the liquid mixture at various temperature ranges. The at least one natural preservative can limit bacterial and fungal growth within the liquid mixture through the use botanical extracts and fermentation products, as well as combinations thereof that carry microbicidal and microbiostatic properties. The at least one natural preservative is found in the present invention ranging between 0.0-4.0% wt. In the preferred embodiment of the present invention, the at least one natural preservative is found being 0.4% wt of the liquid mixture.

The coloring compound in the present invention is provided as a natural extract or compound that provides a visually appealing hue to the liquid mixture. The coloring compound is insoluble in liquid mixture resulting in the coloring compound forming a suspension in the liquid mixture. The suspension formed by the coloring compound provides the liquid mixture with at least partial opacity and a noticeable hue. The coloring compound is found in the present invention ranging between 0.0-10% wt of the liquid mixture. It should be noted that since the coloring compound provided is not explicitly described as forming a particular hue in the liquid mixture, that the coloring compound may be provided to form a plurality of hues, as long as the coloring compound is derived from natural compounds or extracts obtained through non-chemically altering processes. Furthermore, it should be noted that the range provided for the coloring compound implies that the coloring compound can potentially be excluded from specific formulations of the present invention if desired.

The at least one flavoring and water activity reducing compound in the present invention is a natural food additive that provides the present invention with a naturally derived compound that increases the palatability and reduces the water activity of the liquid mixture. The at least one flavoring and water activity reducing compound in the present invention is found present ranging between 0.1-60% wt of the liquid mixture. In the aforementioned quantity ranges the at least one flavoring and water activity reducing compound is able to noticeably alter the palatability of the present invention, wherein the palatability refers to the perception of the five primary flavors, the off-flavor, the on-set and duration, the residual perception, and tactile perception.

It should be noted that the aforementioned ingredients and their respective quantity ranges are described as the preferred embodiment of the present invention. While the at least one natural preservative, the stabilizing and water activity reducing compound, and the high intensity sweetener are specified in the preferred embodiment of the present invention, that the shelf stable liquid sweetener and flavor additive is provided in numerous formulations that vary to a certain extent depending on the intended application. The formulations can be provided to function generally as a combination liquid sweetener and a flavor additive but, can be formulated to function specifically as either a liquid sweetener or as a liquid flavor additive. In each formulation, slight variations are provided in order to enhance the effectiveness of said formulation, and although separate formulations contain ingredient variations, it should be noted that the inclusion or substitution of certain ingredients is an obvious difference that does not detract from the preferred embodiment of the present invention. The formulations are categorized by intended application and comprise a liquid sweetener formulation and a flavor additive formulation. The flavor additive formulation is further subdivided by specific flavoring and comprises a lemonade flavored formulation and a tea flavored formulation. It should be noted that ingredient variations between the lemonade flavored formulation and the tea flavored formulation are obvious differences provided to achieve the water activity (a_{w}) and pH values described in the preferred embodiment of the present invention.

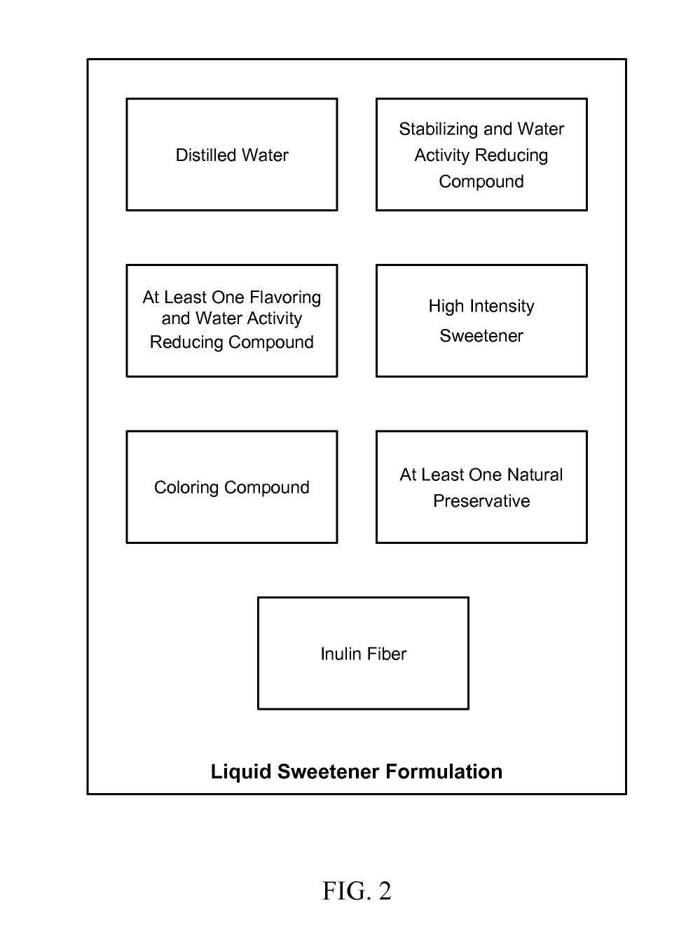

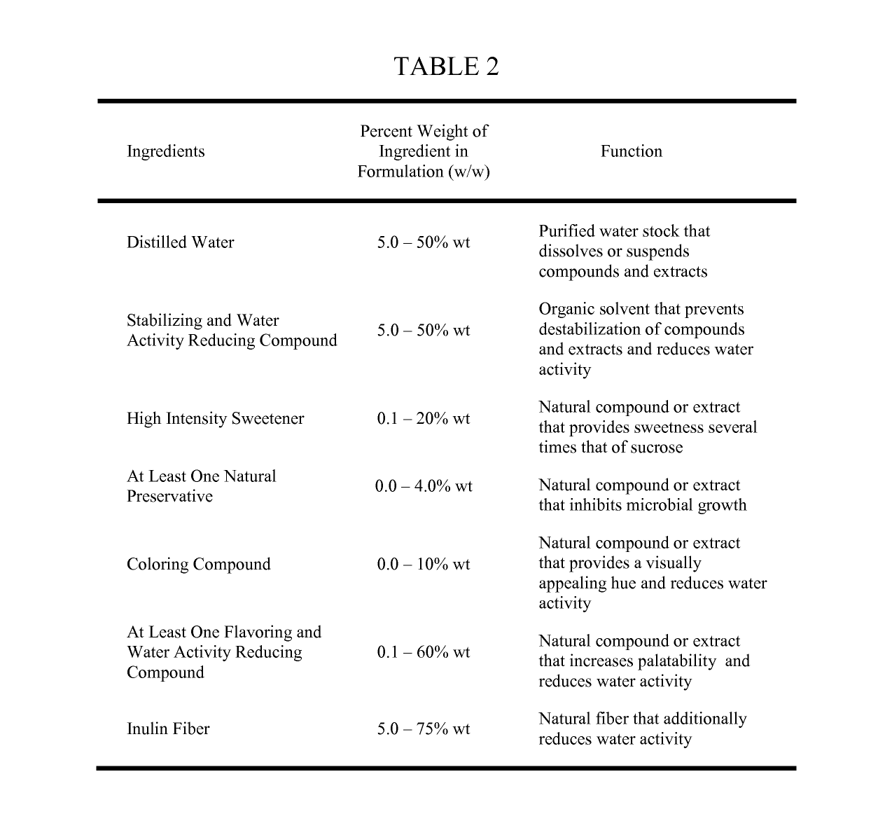

Referencing FIG. 2 and TABLE 2, the liquid sweetener formulation of the shelf stable liquid sweetener and flavor additive is provided as a formulation that is optimally suited to enhance the sweetness of a plurality of food products. The liquid sweetener formulation is similar in many regards to the preferred embodiment of the present invention and comprises distilled water, a stabilizing and water activity reducing compound, a high intensity sweetener, at least one natural preservative, and at least one flavoring and water activity reducing compound. The liquid sweetener formulation varies from the preferred embodiment with the inclusion of inulin fiber.

Referencing FIG. 2 and TABLE 2, the inulin fiber in the liquid sweetener formulation of the present invention functions as a water activity reducing compound but additionally allows the liquid sweetener formulation to function as a nutritional source of fiber, wherein the liquid sweetener formulation could provide 1-20% of the recommended daily allowance of fiber per serving. The inulin fiber, provided as inulin syrup, in the liquid sweetener formulation of the present invention is found present ranging between 5.0-75% wt of the liquid mixture. The inulin fiber, provided as inulin syrup, is short chains of oligofructose, where the oligofructose are derived from the hydrolysis of the long chains of polysaccharides of fructose. The fructose of the oligofructose chains are bound by β-glycosidic bonds that are found in a degree of polymerization of 2-10 throughout the inulin syrup. Due to the inability for humans to break down the β-glycosidic bonds, inulin syrups are classified as fibers. The intrinsic properties of the inulin fiber enable it to function as a water activity reducing compound due to its ability to bind to available water molecules in solution, reducing the vapor pressure of the liquid sweetener formulation of the present invention.

Referencing TABLE 7, the liquid sweetener formulation of the present invention is provided with an exemplary embodiment that contains specific values for each ingredient utilized by the liquid sweetener formulation. The distilled water is found present at 6.5% wt of the exemplary embodiment of the liquid sweetener formulation of the present invention. The stabilizing and water activity reducing compound is found present at 24.45% wt of the exemplary embodiment of the liquid sweetener formulation of the present invention. The inulin fiber is found present at 65% of the exemplary embodiment of the liquid sweetener formulation of the present invention. The high intensity sweetener is found present at 1.15% of the exemplary embodiment of the liquid sweetener formulation of the present invention. The at least one flavoring and water activity reducing compound is found present at 2.5% of the exemplary embodiment of the liquid sweetener formulation of the present invention. Although the coloring compound is not mentioned in the exemplary embodiment of the liquid sweetener formulation, it should be noted that the preferred embodiment of the present invention provides the coloring compound ranging between 0.0-10% wt of the liquid mixture and thus anticipates the absence of the ingredient.

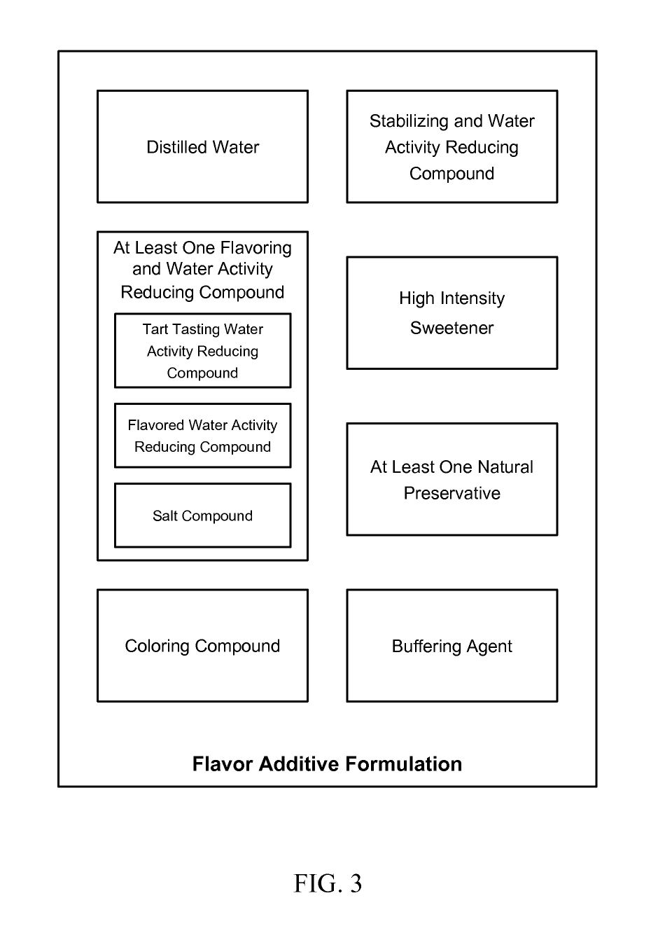

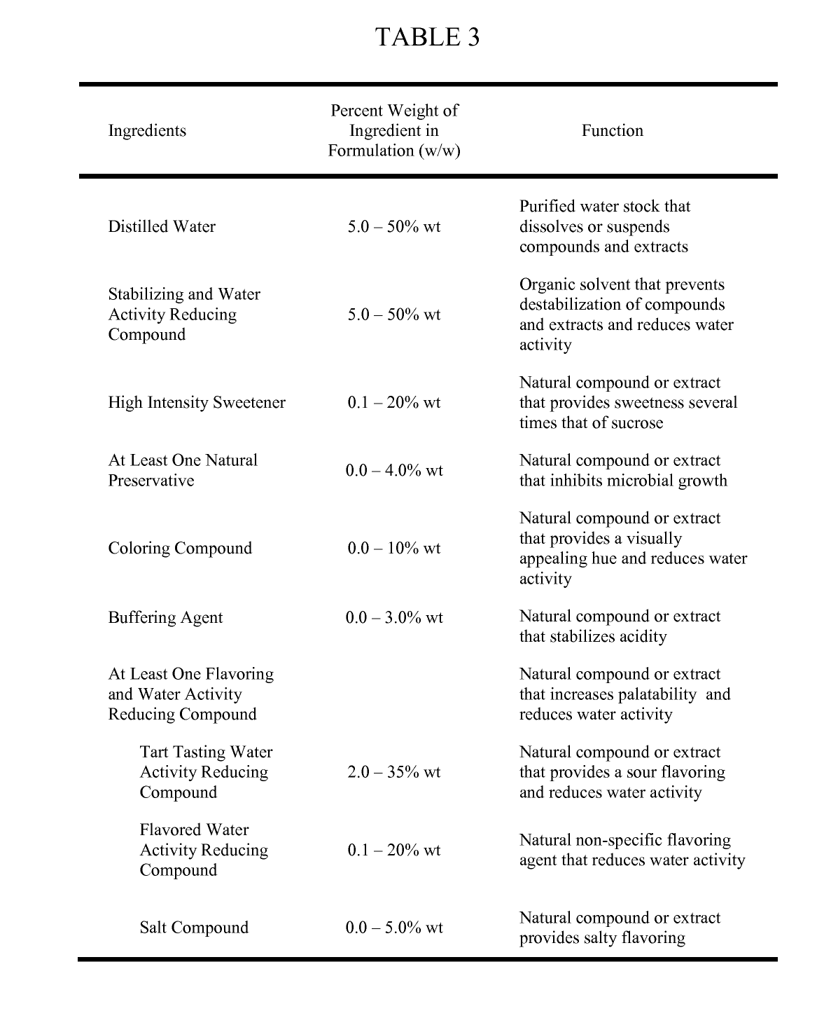

Referencing FIG. 3 and TABLE 3, the flavor additive formulation of the shelf stable liquid sweetener and flavor additive is provided as a formulation that is optimally suited to enhance the palatability of a plurality of food products. The flavor additive formulation is similar to the preferred embodiment of the present invention and comprises distilled water, a stabilizing and water activity reducing compound, a high intensity sweetener, at least one natural preservative, at least one flavoring and water activity reducing compound, and a coloring compound. The flavor additive formulation varies from the preferred embodiment with the inclusion of a buffering agent. In addition to the inclusion of the buffering agent, the flavor additive formulation differs slightly from the preferred embodiment by specifying ingredient composition for the at least one flavoring and water activity reducing compound. The at least one flavoring and water activity reducing compound of the flavor additive formulation further comprises a tart tasting water activity reducing compound, a flavored water activity reducing compound, and a salt compound.

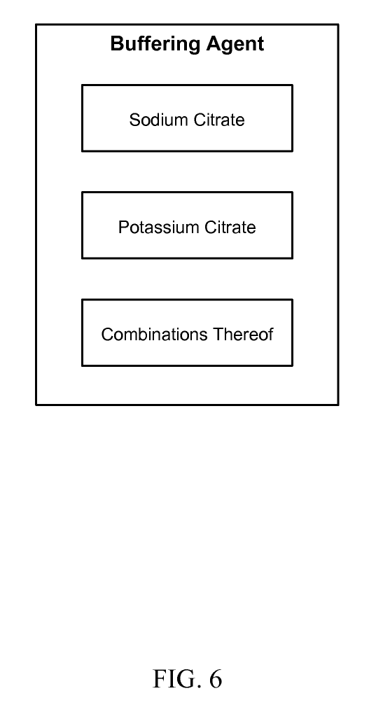

Referencing FIG. 6 and TABLE 4, the buffering agent in the flavor additive formulation of the shelf stable liquid sweetener and flavor additive is provided as a means to maintain the acidity of the flavor additive formulation within a desired pH range. While the acidity of the shelf stable liquid sweetener and flavor additive is generally described as being at a pH value below 4.2, very acidic pH values (pH values of 2.0 and below) can potentially denature or chemically alter the compounds and extracts that are utilized in the flavor additive formulation. In order to prevent unwanted and unintended reactions, a buffering agent is provided at a specific concentration in order to keep the liquid mixture at a desired pH range. The buffering agent in the flavor additive formulation of the present invention is found ranging between 0.0-3.0% wt of the liquid mixture. The inclusion of the buffering agent and the specific compound utilized as the buffering agent is dependent on the quantity of and the compounds selected as the at least one flavoring and water activity reducing compound. In the flavor additive formulation, the buffering agent is selected from a group consisting citrate salts, wherein the group consists of sodium citrate, potassium citrate, and combinations thereof.

Referencing FIG. 3, the at least one flavoring and water activity reducing compound of the flavor additive formulation of the present invention further comprises a tart tasting water activity reducing compound, a flavored water activity reducing compound, and a salt compound. The tart tasting water activity reducing compound is provided as a flavor additive that specifically interacts with the sour taste flavor receptors while additionally reducing the water activity of the liquid mixture. The salt compound is provided as a flavor enhancer that targets the flavor receptors associated with tasting salt. The flavored water activity reducing compound is provided in a similar capacity to the tart tasting water activity reducing compound and the salt compound, it differs in its lack of specificity regarding a target taste or flavor receptors. Although the function of the tart tasting water activity reducing compound, the flavored water activity reducing compound, and the salt compound are consistent in both variations of the flavor additive formulation, quantities and elected compounds vary between the lemonade flavored formulation and the tea flavored formulation.

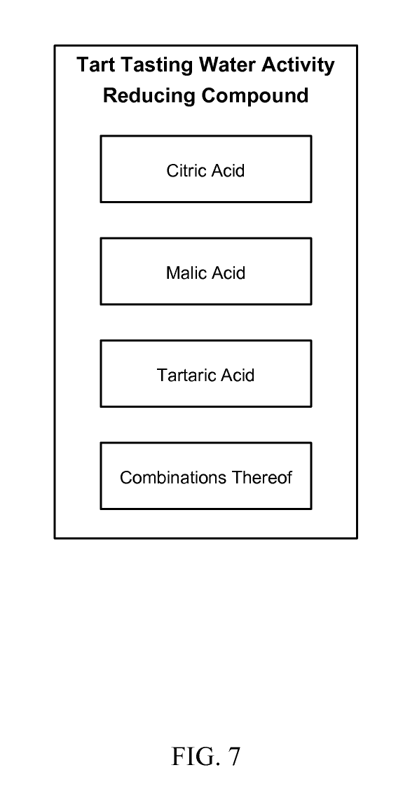

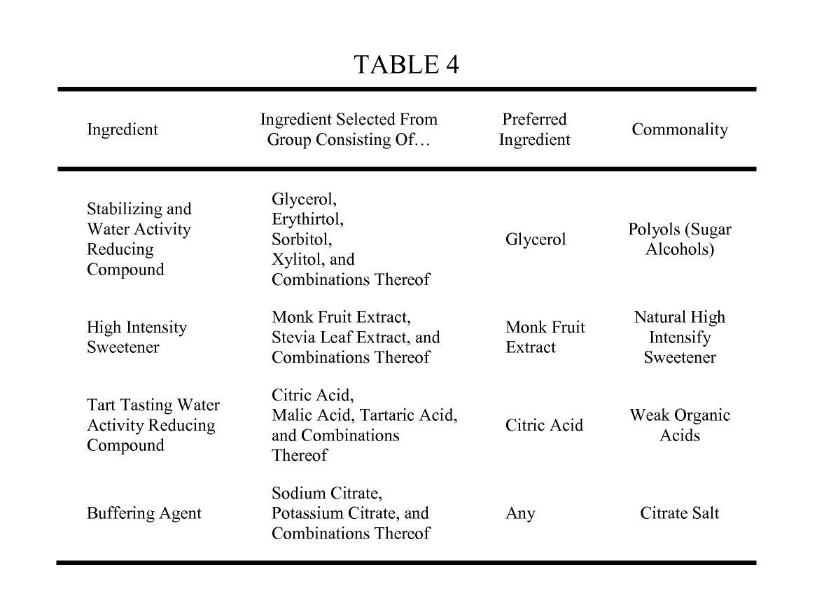

Referencing FIG. 7 and TABLE 3, the tart tasting water activity reducing compound in the flavor additive formulation provides the present invention with a combination flavor that interacts with the sour tastes but additionally lowers the water activity of the flavor additive formulation. The tart tasting water activity reducing compound in the present invention is found ranging between 2.0-35% wt of the liquid mixture. The tart tasting water activity reducing compound is selected from a group of organic acids that consists of a citric acid, malic acid, tartaric acid, and combinations thereof. The exemplary embodiment of the flavor additive formulation the tart tasting and water activity reducing compound is citric acid. Citric acid is selected as the preferred compound for the tart tasting water activity reducing compound for its well documented versatility as a flavoring agent in a plurality of food products. Citric acid is a weak organic acid that provides a sour taste that is generally described as having a tart flavor profile. Citric acid functions primarily as an acidifier and flavoring agent but, also reduces the water activity of the flavor additive formulation. Citric acid is able to lower the water activity of the flavor additive formulation.

The salt compound in the flavor additive formulation of the present invention provides the shelf stable liquid sweetener and flavor additive, with a flavor enhancer that targets flavor receptors associated with saltiness. The salt compound in the present invention is found ranging between 0.0-5.0% wt of the liquid mixture. The salt compound functions primarily as a flavor enhancer in the flavor additive formulation of the present invention.

The flavored water activity reducing compound of the flavor additive formulation provides the present invention with a non specific flavoring agent that additionally functions as a water activity reducing compound. The flavored water activity reducing compound is found ranging between 0.1-20% wt of the flavor additive formulation. While the specific flavorings are selected in the formulations of the lemonade flavored formulation and the tea flavored formulation, the flavored water activity reducing compound is generally understood as a naturally occurring compound, extract, combination thereof that functions as a flavoring agent that can also reduce the water activity of the liquid mixture. While the flavored water activity reducing compound is described as a single compound, it should be understood that the flavored water activity reducing compound can comprises multiple compounds and combinations of compound that function together to achieve a desired flavor profile.

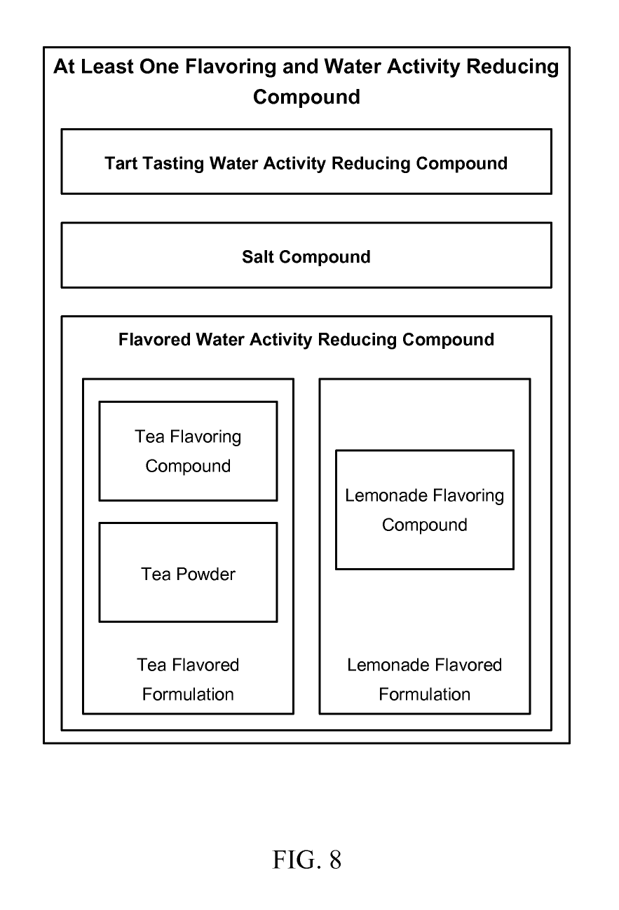

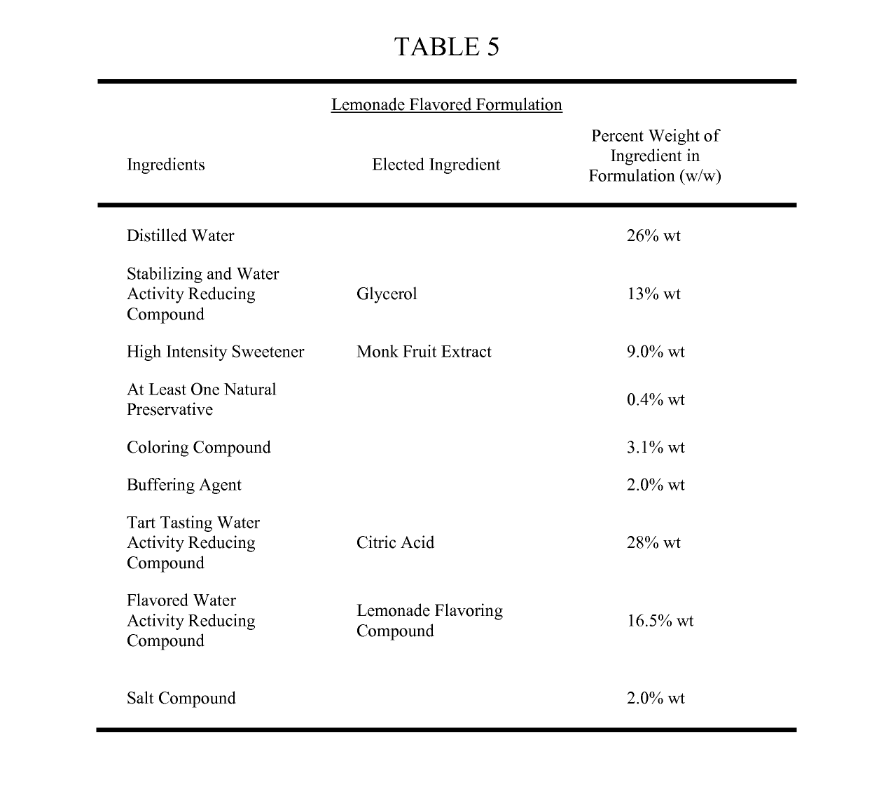

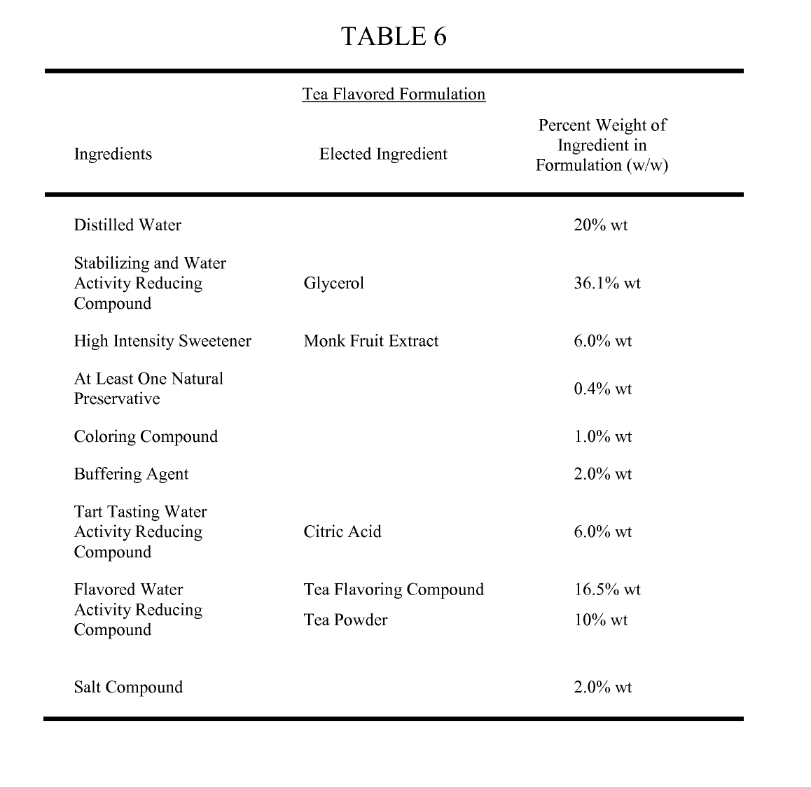

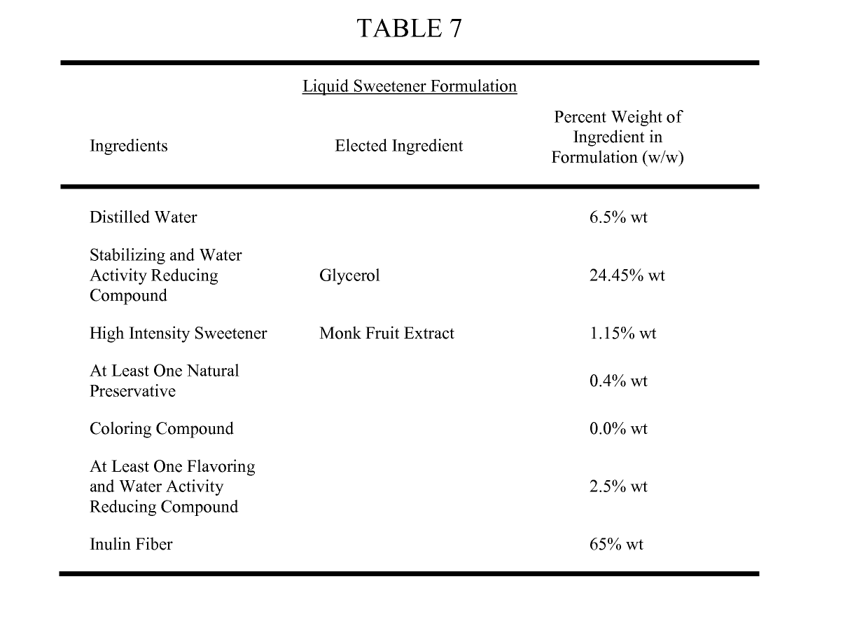

Referencing FIG. 8, in the lemonade flavored formulation, the flavored water activity reducing compound further comprises lemonade flavoring compound. The lemonade flavoring compound is provided to function as a flavoring agent that produces a flavoring profile that resembles lemonade. The lemonade flavoring compound additionally functions as a water activity reducing compound. Although the compound utilized as the lemonade flavoring compound is not explicitly described it should be understood that any natural compound, extract, or combination thereof that is able to provide a lemonade flavor and reduce the water activity of the present invention could potentially be utilized.

Referencing TABLE 5, the lemonade flavored formulation of the present invention is provided with an exemplary embodiment that contains specific quantity values for each ingredient utilized in the lemonade flavored formulation. The distilled water is found present at 26% wt of the exemplary embodiment of the lemonade flavored formulation of the present invention. The stabilizing and water activity reducing compound is found present at 13% of the exemplary embodiment of the lemonade flavored formulation of the present invention. The high intensity sweetener is found present at 9% wt of the exemplary embodiment of the lemonade flavored formulation of the present invention. The lemonade flavoring compound is found present at 16.5% wt of the exemplary embodiment of the lemonade flavored formulation of the present invention. The salt compound is found present at 2.0% wt of the exemplary embodiment of the lemonade flavored formulation of the present invention. The buffering agent is found present at 2.0% wt of the exemplary embodiment of the lemonade flavored formulation of the present invention. The coloring compound is found present at 3.1% wt of the exemplary embodiment of the lemonade flavored formulation of the present invention.

Referencing FIG. 8, in the tea flavored formulation, the flavored water activity reducing compound further comprises a tea flavoring compound and tea powder. The tea flavored compound and the tea powder function cooperatively to provide the tea flavored formulation with a flavor profile that resembles flavors associated with tea drinks. The tea flavoring compound is provided as a natural compound, extract, or combination thereof, that functions as a flavoring agent that produces a flavor profile that resembles flavors associated with tea drinks. Additionally the tea flavored compound functions as a water activity reducing compound in the tea flavored formulation. While it is generally understood that teas can be derived from a plurality of plants, and thus have a plurality of flavor profiles, it should be noted that similarities exist between most tea beverages and thus a generalized flavor profile can be created to function as a place holder for the various tea flavors. Tea powder is provided as a flavor enhancer that functions cooperatively with the tea flavored compound. The tea powder is derived from botanical extracts that are purified through non-chemically altering means to form a concentrated powder. The tea powder enhances the tea flavoring of the tea flavored formulation but additionally provides a natural coloring to the liquid mixture.

Referencing TABLE 6, the tea flavored formulation of the present invention is provided with an exemplary embodiment that contains specific quantity values for each ingredient utilized in the tea flavored formulation. The distilled water is found present at 20% wt of the exemplary embodiment of the tea flavored formulation of the present invention. The stabilizing and water activity reducing compound is found present at 36.1% wt of the exemplary embodiment of the tea flavored formulation of the present invention. The high intensity sweetener is found present at 6.0% wt of the exemplary embodiment of the tea flavored formulation of the present invention. The tart tasting water activity reducing compound is found present at 6.0% wt of the exemplary embodiment of the tea flavored formulation of the present invention. The tea flavoring compound is found present at 16.5% wt of the exemplary embodiment of the tea flavored formulation of the present invention. The tea powder is found present at 10% wt of the exemplary embodiment of the tea flavored formulation of the present invention. The salt compound is found present at 2.0% wt of the exemplary embodiment of the tea flavored formulation of the present invention. The buffering agent is found present at 2.0% wt of the exemplary embodiment of the tea flavored formulation of the present invention. The coloring compound is found present at 1.0% wt of the exemplary embodiment of the tea flavored formulation of the present invention.

In the current embodiment of the present invention the stabilizing and water activity reducing compound is selected from a group consisting of polyols. Polyols are organic molecules with multiple hydroxyl groups that when described in the food science, generally refer to sugar alcohols. Although polyols exist naturally, they are often synthesized through chemical processes. These chemical processes include but are not limited to hydrogenation, acid hydrolysis, or pyrolysis. While synthesized polyols are regularly incorporated in food products, it is the aim of the present invention to provide ingredients that are naturally formed compounds or extracts obtained through non-chemically assisted or chemically altering processes. Furthermore, while the stabilizing and water activity reducing compound is selected from a group of polyols that consists of Glycerol, Erythritol, Sorbitol, Xylitol, and combinations thereof, additional embodiment of the present invention can expand the group of polyols to consist of Malitol, Mannitol, Lactitol, polyglycitol, as well as combination thereof.

In the current embodiment of the present invention the stabilizing and water activity reducing compound selected as glycerol primarily functions as an organic solvent that reduces unwanted and unintended molecular interaction. Although glycerol is provided as a molecular stabilizer, it is well documented that glycerol can additionally function as a microbial stabilizer. Glycerol is difficult to process by many bacteria enabling its bacteriostatic properties. While the microbial stabilizer in the current embodiment of the present invention is provided by the at least one natural preservative, glycerol bacteriostatic properties provide it with a functional overlap with the at least one natural preservative.

In the current embodiment of the present invention the high intensity sweetener provided is selected from a group consisting of monk fruit extract, Stevia leaf extract, and combinations thereof. Monk fruit comes from an herbaceous perennial vine, Siraitia grosvenorii, that is native to the tropical regions of South Eastern Asia. Extracts from the monk fruit have been found to be approximately 150-400 times sweeter than sugar. The active compound in monk fruit extract are triterpene glycosides or mogrosides, which consists of Mogroside II A¹, Mogroside II B, 7-Oxomogroside II E, 11-Oxomogroside A¹, Mogroside III A², 11-Deoxymogroside III, 11-Oxomogroside IV A, Mogroside V, 7-Oxomogroside V, and 11-Oxo-mogroside V. The monk fruit extract is obtained through non-chemically assisted means. The monk fruit extract is isolated from the monk fruit by crushing the fruit and infusing it with hot water to extract all the natural sweetness. Stevia is a genus of herbs and shrubs native to the subtropical regions of north and South America. In the current embodiment of the present invention the source of the Stevia leaf extract is derived from ground leaves of Stevia rebaudiana. The extracts from the leaves of the Stevia plants have been found to contain steviol glycosides, which are known to have 300 times the sweetness of sucrose. Stevia leaf extract is obtained through non-chemically assisted means in a process similar to that utilized in obtaining monk fruit extract.

In the present invention, the high intensity sweetener is selected from a group that consists of monk fruit extract, Stevia leaf extract, and combinations thereof. While the high intensity sweetener is limited to the above mentioned natural extracts, additional embodiment can expand the group to include thaumatin extract (Thaumatococcus danielli), hernandulcin extract (Lippia dulcis), Brazzein extract (Pentadiplandra brazzeana Baillon), neohesperidin, and any a combination of these or other natural extracts known to those skilled in the art as possessing sweetness or flavor enhancing properties and being suitable for application in food and beverage products.

In the current embodiment of the present invention the at least one natural preservative is generally described as being a natural compound or extract that functions as a microbiological stabilizer. Although a particular natural compound is not explicitly described as being the at least one natural preservative in the current embodiment of the present invention, it should be understood that the at least one natural preservative can be selected from a group consisting of commonly utilized natural preservatives that includes plant extracts, fruit extracts, and microbial fermentation products. The at least one natural preservative can be selected from a group of plant extracts that include but is not limited to oregano, thyme, rosemary, sage, lemongrass, and any combination thereof. The at least one natural preservative can be selected from a group of fruit extracts collected from peels, leaves, flowers, seeds and fruit bodies from species that include but are not limited to fruits in the Citrus genus and combinations thereof. The at least one natural preservative can be selected from a group consisting of microbial fermentation products with antimicrobial potentials that include but not limited to Nisin, Natamycin, Polylysine, Pediocin, Reuterin, and any combination thereof. The at least one natural preservative can be selected from a group consisting of botanical extracts containing antimicrobial phenolic and polyphenolic compounds obtained either by direct extraction from botanical sources and or by enzymatic or microbial fermentation of these sources.

In the current embodiment of the present invention the determination of the shelf stability is predicted based on the composition of the formulation and the specific quantity of natural ingredients utilized in preferred embodiment of the shelf stable liquid sweetener and flavor additive. Although rigorous experimentation has not yet been conducted to determine an exact shelf life, formulations with similar values for water activity and pH have been determined to hold for 9-18 months in standard conditions of temperature and pressure. While the predicted shelf life is extrapolated from existing formulations, the present invention can easily be incorporated into current food safety laboratory experimentation similar to those used by the National Advisory Committee on Microbiological Criteria for Foods (NACMCF) as well as those utilized by the Food and Drug Administration for Microbial analysis for process validation to determine an actual shelf life range. The laboratory experimentation would consist of conducting microbial testing using standardized methods at the beginning and end of the intended product use life. The microbial analysis would be conducted on representative samples of intact, finished, packaged product within 24 hours of being packaged and again with the sample being held at a temperature of 32° C., 90° F., and determining if the limits for each would coincide with the predicted growth rates. The microbial tests conducted would include an Aerobic Plate Count, Coagulase positive Staphylococcus aureus, Coliforms, a heat resistant mold, osmophilic yeast, an alicyclobacillus, and Salmonella, all of which would be tested using the FDA's Bacteriological Analytical Manual methods for each respective microbe or an equivalent method.

In the current embodiment of the present invention, the at least one flavoring and water activity reducing compound is provided in two formulations that consist of a lemonade flavored formulation and a tea flavored formulation. While only two flavor formulations are described, it should be understood that the preferred embodiment of the present invention provides for any flavor formulation to be utilized as long as the at least one flavoring and water activity reducing compound is provided as a naturally occurring compound or extract that is obtained through non-chemically altered or chemically assisted means.

In the current embodiment of the present invention, the shelf stable liquid sweetener and flavor additive can be provided in a hermitically sealed single use container. The hermitically sealed single use container would function similar to existing containers that are utilized as delivery systems for liquid food products with similar consistency. There are many of these possible delivery systems, including but not limited to disposable vials, condiment packets, as well as dissolvable gel tablets. Additionally, it is possible for the present invention to be incorporated into a multi use container. These multiuse containers include but are not limited to re-sealable containers and pressure assisted dispensers, the selection of a particular container would depend on the composition of the present invention as well as its preferred use.

The current embodiment of the present invention is provided as a liquid sweetener and flavor additive that allows it to be incorporated into a plurality of food products.

Many of these food products are already associated with the existing sweeteners and could therefore utilize the present invention in as a substitution. The present invention can function as a substitute sweetener in a plurality of food products that include, but are not limited to, beverages, baked goods, and condiments. Additionally, the present invention can potentially be used as a stable concentrated base for delivering nutritional ingredients or bioactive components that include but are not limited to vitamins, minerals, caffeine, plant extracts and combinations thereof. Furthermore, the present invention can serve as a flavor additive in condiments such as hot sauces, ketchup concentrates, and steak sauces. It should also be noted that the present invention can be provided for use in any food product, which includes human food products as well as animal food products. In this capacity the present invention can be provided as a flavor enhancer for pet foods.

In an additional embodiment, the present invention could be optimized for use as a flavor additive of a particular beverage such as water, which could be consumed by either humans or pets. In this additional embodiment the composition comprises water, high intensity sweeteners, natural flavors, natural colors, acidulants, buffering agents. Other ingredients such as polysaccharides, agave syrup, honey, syrups, fruit concentrates, botanical extracts such as tea extracts, coffee extract may be added. This composition may be used for pleasantly enhancing the flavor of water or any other beverage when added at a ratio of 1:50-1:250 (v/v). Preferably this composition may be added to water or beverages to enhance the flavor at a ratio of 1:100-1:150 (v/v) and more preferably this composition may be added at a ratio of 1:110-1:140 (v/v).

In an additional embodiment of the present invention the composition is configured in a manner that is optimized for use as a flavor enhancer for beverages including water. This composition comprises water, high intensity sweeteners, natural flavors, natural colors, acidulants, buffering agents. Other ingredients such as polysaccharides, vitamins, minerals, appetite suppressant, aromatics, honey, syrups, fruit concentrates, botanical extracts such as tea extracts, coffee extract may be added.

In an additional embodiment of the present invention the composition is configured in a manner that is optimized for use as a flavor enhancer for beverages including water. This composition comprises water, high intensity sweeteners, natural flavors, natural colors, acidulants, buffering agents. Other ingredients such as active pharmaceutical agents, botanical extracts and other components commonly incorporated into dietary supplements may be added to conveniently deliver specific health benefits.

Although the invention has been explained in relation to its preferred embodiment, it is to be understood that many other possible modifications and variations can be made without departing from the spirit and scope of the invention as hereinafter claimed.

What is claimed is:

1. A shelf stable liquid sweetener and flavor additive comprises:
a.) distilled water;
b.) a stabilizing and water activity reducing compound;
c.) a high intensity sweetener (HIS);
d.) at least one natural preservative;
e.) at least one flavoring and water activity reducing compound;
f.) a coloring compound;
the shelf stable liquid sweetener and flavor additive having a water activity (a_{w}) being below 0.8 and a pH below 4.2;
the distilled water being present at a range between 5.0-50% wt;
the stabilizing and water activity reducing compound being present at a range between 5.0-50% wt;
the high intensity sweetener (HIS) being present at a range between 0.1-20% wt;
the at least one natural preservative being present at a range between 0.0-4.0% wt;
the at least one flavoring and water activity reducing compound being present at a range between 0.1-60% wt;
the coloring compound being present at a range between 0.0-10% wt;

2. The shelf stable liquid sweetener and flavor additive of claim 1, wherein the at least one natural preservative being present at 0.4% wt.

3. The shelf stable liquid sweetener and flavor additive of claim 1, wherein the stabilizing and water activity reducing compound is selected from the group consisting of Glycerol, Erythritol, Sorbitol, Xylitol, and combinations thereof.

4. The shelf stable liquid sweetener and flavor additive of claim 3, wherein the stabilizing and water activity reducing compound is Glycerol.

5. The shelf stable liquid sweetener and flavor additive of claim 1, wherein the high intensity sweetener (HIS) is selected from the group consisting of Monk fruit extract, Stevia leaf extract, and combinations thereof.

6. The shelf stable liquid sweetener and flavor additive of claim 5, wherein the high intensity sweetener (HIS) is Monk fruit extract.

7. The shelf stable liquid sweetener and flavor additive as claimed in claim 1 comprises:
a buffering agent;
the at least one flavoring and water activity reducing compound comprises a tart tasting water activity reducing compound, a flavored water activity reducing compound, and a salt compound;
the buffering agent is sodium citrate, potassium citrate, or a combination thereof;
the buffering agent being present at a range between 0.0-3.0% wt;
the tart tasting water activity reducing compound being present at a range between 2.0-35% wt;
the flavored water activity reducing compound being present at a range between 0.1-20% wt;
the salt compound being present at a range between 0.0-5.0% wt;

8. The shelf stable liquid sweetener and flavor additive of claim 7, wherein the tart tasting water activity reducing compound is selected from the group consisting of citric acid, malic acid, tartaric acid, and combinations thereof.

9. The shelf stable liquid sweetener and flavor additive of claim 8, wherein the tart tasting water activity reducing compound is citric acid.

10. The shelf stable liquid sweetener and flavor additive as claimed in claim 7 comprises:
the flavored water activity reducing compound comprises a lemonade flavoring compound;
the distilled water being present at 26% wt;
the stabilizing and water activity reducing compound being present at 13% wt;
the high intensity sweetener being present at 9.0% wt;
the tart tasting water activity reducing compound being present at 28% wt;
the lemonade flavoring compound being present at 16.5% wt;
the salt compound being present at 2.0% wt;
the buffering agent being present at 2.0% wt;
the coloring compound being present at 3.1% wt;

11. The shelf stable liquid sweetener and flavor additive as claimed in claim 7 comprises:
the flavored water activity reducing compound comprises a tea flavoring compound and tea powder;
the distilled water being present at 20% wt;
the stabilizing and water activity reducing compound being present at 36.1% wt;
the high intensity sweetener being present at 6.0% wt;
the tart tasting water activity reducing compound being present at 6.0% wt;
the tea flavoring compound being present at 16.5% wt;
the tea powder being present at 10% wt;
the salt compound being present at 2.0% wt;
the buffering agent being present at 2.0% wt;
the coloring compound being present at 1.0% wt;

12. A shelf stable liquid sweetener and flavor additive comprises:
a) distilled water;
b) a stabilizing and water activity reducing compound;
c) a high intensity sweetener (HIS);
d) at least one natural preservative;
e) at least one flavoring and water activity reducing compound;
f) a coloring compound;
the shelf stable liquid sweetener and flavor additive having a water activity (a_{w}) being below 0.8 and a pH below 4.2;
the distilled water being present at a range between 5.0-50% wt;
the stabilizing and water activity reducing compound being present at a range between 5.0-50% wt;
the high intensity sweetener (HIS) being present at a range between 0.1-20% wt;
the at least one natural preservative being present at a range between 0.0-4.0% wt;
the at least one flavoring and water activity reducing compound being present at a range between 0.1-60% wt;
the coloring compound being present at a range between 0.0-10% wt;

13. The shelf stable liquid sweetener and flavor additive of claim 12, wherein the at least one natural preservative being present at 0.4% wt.

14. The shelf stable liquid sweetener and flavor additive of claim 12, wherein the stabilizing and water activity reducing compound is selected from the group consisting of Glycerol, Erythritol, Sorbitol, Xylitol, and combinations thereof.

15. The shelf stable liquid sweetener and flavor additive of claim 14, wherein the stabilizing and water activity reducing compound is Glycerol.

16. The shelf stable liquid sweetener and flavor additive of claim 12, wherein the high intensity sweetener (HIS) is selected from the group consisting of Monk fruit extract, Stevia Leaf extract, and combinations thereof.

17. The shelf stable liquid sweetener and flavor additive of claim 16, wherein the high intensity sweetener (HIS) is Monk fruit extract.

18. The shelf stable liquid sweetener and flavor additive as claimed in claim 12 comprises:
inulin fiber;
the inulin fiber being present at a range between 5.0-75% wt;

19. The shelf stable liquid sweetener and flavor additive as claimed in claim 18 comprises:
the distilled water being present at 6.5% wt;
the stabilizing and water activity reducing compound being present at 24.45% wt;
the inulin fiber being present at 65% wt;
the high intensity sweetener being present at 1.15% wt;
the at least one flavoring and water activity reducing compound being present at 2.5% wt;
the coloring compound being present at 0.0% wt;
